(19) United States
(12) Patent Application Publication
(10) Pub. No.: US 2004/0073430 A1
(43) Pub. Date: Apr. 15, 2004

(54) Intelligent media processing and language architecture for speech applications

(76) Inventors: Ranjit Desai, Sudbury, MA (US); Sugata Mukhopadhyay, Chelmsford, MA (US); Jayanta K. Dey, Cambridge, MA (US); Rajendran M. Sivasankaran, Somerville, MA (US); Adam Jenkins, Somerville, MA (US); Michael Swain, Newton, MA (US)

Correspondence Address: LACASSE & ASSOCIATES, LLC, 1725 DUKE STREET, SUITE 650, ALEXANDRIA, VA, 22314, US

(21) Appl. No.: 10/267,929

(22) Filed: Oct. 10, 2002

(51) Int. Cl. G10L 21/00

(52) U.S. Cl. 704/270.1

(57) ABSTRACT

A modular architecture is described for providing an intelligent media processing and language architecture working in conjunction with a speech application. The modular architecture comprises four modules: a user profile module, an active audio markup language (AAML) module, a real-time monitoring and sensing module, and a process and control module. The user profile module enables creation of personal profiles and is capable of learning user preferences. The AAML module provides a rich media representation wherein an AAML codec is provided as a part of the module. The processing and control module is responsible for processing the information received from each of the other modules, interpreting the received information, and intelligently routing it to the application layer.

### BACKGROUND OF THE INVENTION

1. Field of Invention The present invention relates generally to the field of speech processing. More specifically, the present invention is related to efficient implementations of speech-based interfaces.

2. Discussion of Prior Art

Speech-based interfaces have the potential to provide a very natural interaction with knowledge-based systems. For example, these systems provide the users with the capability to rapidly access, share, and manage valuable information (e.g., store and retrieve time-critical information in a database). However, existing speech-based architectures are severely restricted with regard to personalization of such applications. This leads to an inefficient and frustrating user experience, thereby hindering the rapid deployment and adoption of speech-driven applications.

Existing core architectures upon which speech applications are designed suffer from several drawbacks, some examples being:

(i) The lack of support to personalize entry and retrieval of information during a call. In effect, all users are forced to enter or listen to the same information in exactly the same way. This leads to an inferior user experience.

(ii) The inability to pre-compute information and store it efficiently so that application designers can process and present this information in a meaningful manner without incurring large performance penalties.

(iii) The lack of real-time monitoring and sensing of the Quality of Service (QOS) parameters such as presence of delays and noise. This prevents application designers from providing corrective mechanisms based on real-time information.

Thus, prior art speech-based systems fail to provide for extensive customization and personalization capabilities for a natural interaction. Whatever the precise merits, features, and advantages of the above-mentioned speech-based systems, none of them achieves or fulfills the purposes of the present invention.

### SUMMARY OF THE INVENTION

The present invention provides for a modular Intelligent Media Processing And Language Architecture (IMPALA) that addresses many shortcomings associated with prior art speech-based applications. The present invention's architecture comprises four modules: (a) a user profile module; (b) an Active Audio Markup Language (AAML) module; (c) a real-time monitoring and sensing module; and (d) a processing control module.

The user profile module enables the creation of personal profiles based on user preferences by analyzing the interaction between the application and the user. Additionally, this module is also capable of learning the user's preferences.

The AAML module provides a rich media representation, which naturally facilitates a superior user experience (e.g., eliminate annoying noise, provide ease of navigation, and anticipating the user's needs). A codec is provided in this module, which allows one or more audio streams to be encoded into a single AAML stream. It should be noted that the encoding process is carried out offline while decoding is carried out in real-time.

The real-time monitoring and sensing module, on the other hand, provides the ability to handle variations in the quality of service (QOS). QOS can depend on the type of device, type of connection (land lines versus mobile phones), and location of the caller. This module senses ambient conditions and allows for the design and implementation of intelligent applications that are based on decisions made in real-time, as opposed to having a preconceived decision flow.

The processing and control module is responsible for processing the information received from each module described above, interpreting it, and intelligently routing it to the application layer to achieve the desired behavior.

The components of the IMPALA architecture are well suited for designing natural interfaces for applications such as navigation and browsing of traditional content management systems using speech- and voice-based interfaces. Each component of the architecture provides a significant advancement over existing technology. The novel manner in which speech-based applications are provided the capability to learn and constantly refine their performance marks an advance in the way natural interfaces are being developed. Another innovation is the Active Audio Mark Up Language (AAML), which describes a rich, structured format for representing native audio streams. This format makes it possible to include multi-modal information and is extensible to a multitude of devices including next generation mobile phones and hand-held devices. The real-time processing and sensing module introduces the concept of combining ambient information and providing applications with intelligence to make appropriate decisions leading to highly dynamic interaction between users and automated systems. Another unique feature of the present invention is the novel modular framework, which can be used for building highly adaptive, sophisticated applications allowing a high degree of personalization. This degree of sophistication is a significant advancement in state-of-the-art speech application architectures. Another unique aspect of this framework is its flexibility, such that the components can be used in conjunction or independently of each other and can be extended to a host of playback devices such as telephones, personal audio systems, or wireless devices.

### BRIEF DESCRIPTION OF THE DRAWINGS

FIG. 1 illustrates the present invention's modularized IMPALA architecture.

FIG. 2 illustrates an implementation of a sample application based on the IMPALA architecture.

FIG. 3 illustrates the two streaming modes associated with the transmission (in an AAML format) of raw audio data from the database of FIG. 2.

FIG. 4 illustrates a sample AAML stream.

### DESCRIPTION OF THE PREFERRED EMBODIMENTS

While this invention is illustrated and described in a preferred embodiment, the invention may be produced in many different configurations, forms, and materials. There is depicted in the drawings, and will herein be described in detail, a preferred embodiment of the invention, with the understanding that the present disclosure is to be considered an exemplification of the principles of the invention and the associated functional specifications for its construction and is not intended to limit the invention to the embodiment illustrated. Those skilled in the art will envision many other possible variations within the scope of the present invention.

It should be noted that although the description provided below uses a specific media type, i.e., audio data, to illustrate the functionality associated with the present invention, it should be noted that the present invention is not restricted to just audio data, and hence one skilled in the art can extend the modularized IMPALA system to be fully functional with other media types such as, but not limited to, video, static images, and/or multimedia data.

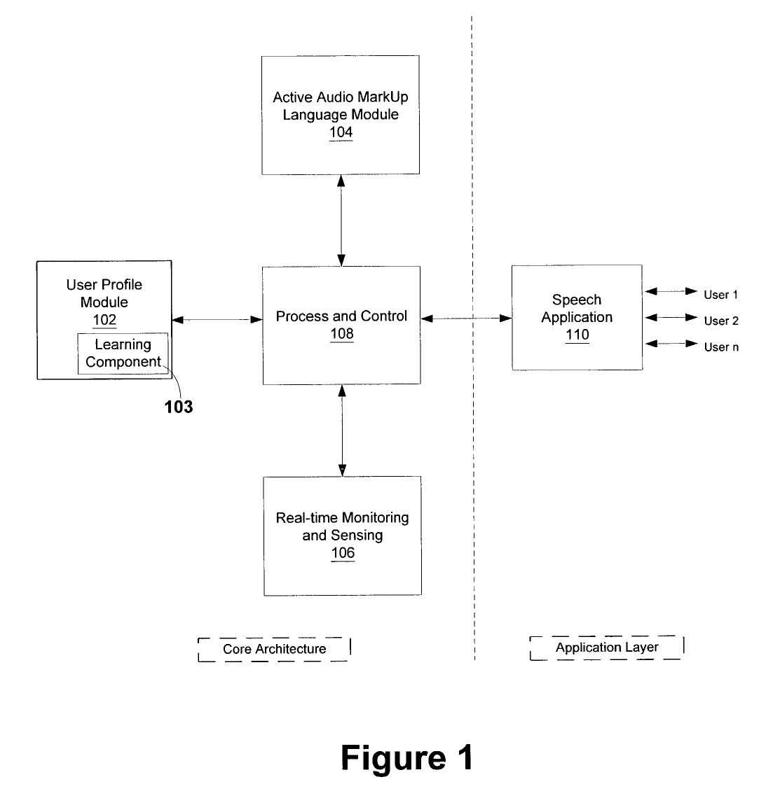

FIG. 1 illustrates the modular nature of the present invention's IMPALA architecture. The core architecture comprises four modules: (a) a user profile module 102; (b) an active media markup language module such as an AAML module 104; (c) a real-time monitoring and sensing module 106; and (d) a processing control module 108. As shown in FIG. 1, multiple users are able to simultaneously access the system using independent recording and playback devices (such as wireline and wireless devices such as telephones and/or personal computers equipped with microphones and loudspeakers) to enter and retrieve multimedia data (such as audio data). The user profile module 102 enables creation of personal profiles and learns (via a learning component 103) the user's preferences by analyzing the interaction between the application 110 and the user. The AAML module 104 provides a rich media representation that facilitates a more natural interface. A codec is provided in this module, which allows one or more audio streams to be encoded into a single AAML stream. It should be noted that the encoding process is carried out offline while decoding is carried out in real-time. The real-time monitoring and sensing module 106 senses the ambient conditions and allows applications the ability to respond intelligently based on decisions made in real-time. The processing and control module 108 is responsible for coordinating the interaction between the three components 102, 104, and 106 and the application layer.

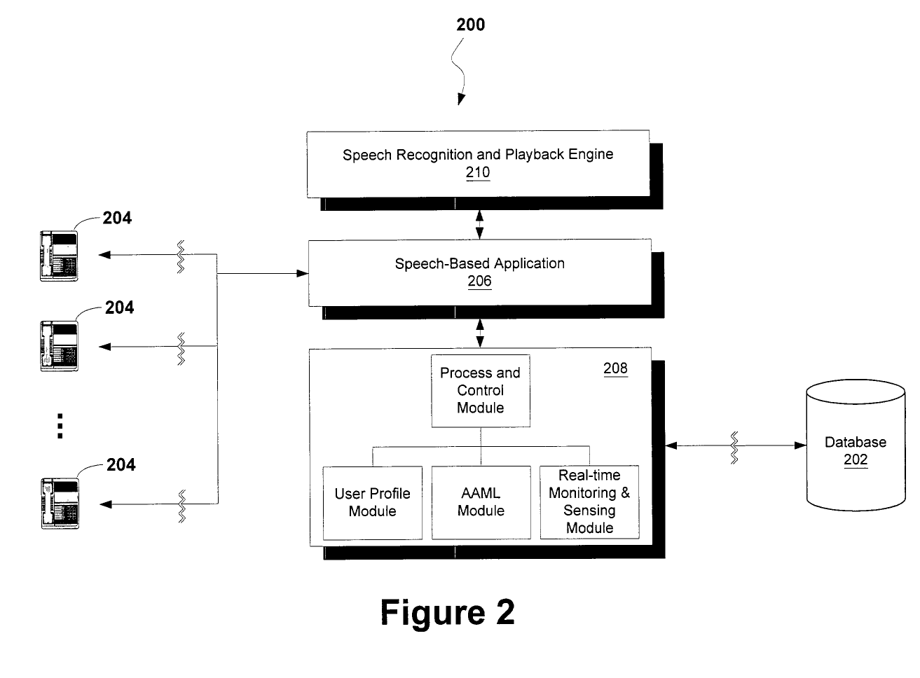

Each module in the IMPALA architecture addresses a specific capability that application designers can take advantage of. FIG. 2 illustrates an implementation 200 of a sample application based on the modularized aspect of the present invention's architecture. In this example, users are able to access a remote database 202 from telephone 204 to enter/retrieve information. This application would let users call a telephone number, identify themselves, and enter/retrieve information using spoken commands. The speech-based application 206 is built on top of the present invention's core IMPALA architecture 208, which is able to process user inputs, communicate with a speech recognition and playback engine 210 to recognize the spoken commands, perform the necessary actions, and playback the information to the user.

In this setup, the application designer first creates a list of users who are allowed to access the database 202. The application designer is able to create a personal profile for each user using the user profile module (102 in FIG. 1). This module allows the user to tweak several preferences (e.g., preferred volume, speed, playback voice, and/or accent) regarding how the received information should be played back. In addition to the user being able to select features, the user profile module also permits the system to learn a user's preferences (via learning component 103 of FIG. 1) and tune the speech recognition and system accordingly. Additionally, the module is also able to capture the idiosyncrasies in a user's speech pattern, such as: pronunciation, cadence, volume, and accent. Tuning the system based on these learnt parameters results in fewer errors and presents the user with a more intuitive and natural interface.

The audio information in database 202 is stored using an AAML framework that allows the information to be parsed meaningfully and analyzed based on computing statistical measures and information markers corresponding to semantic events. As mentioned earlier, the encoding process is carried offline, however, online embodiments should not depart from the scope of the present invention.

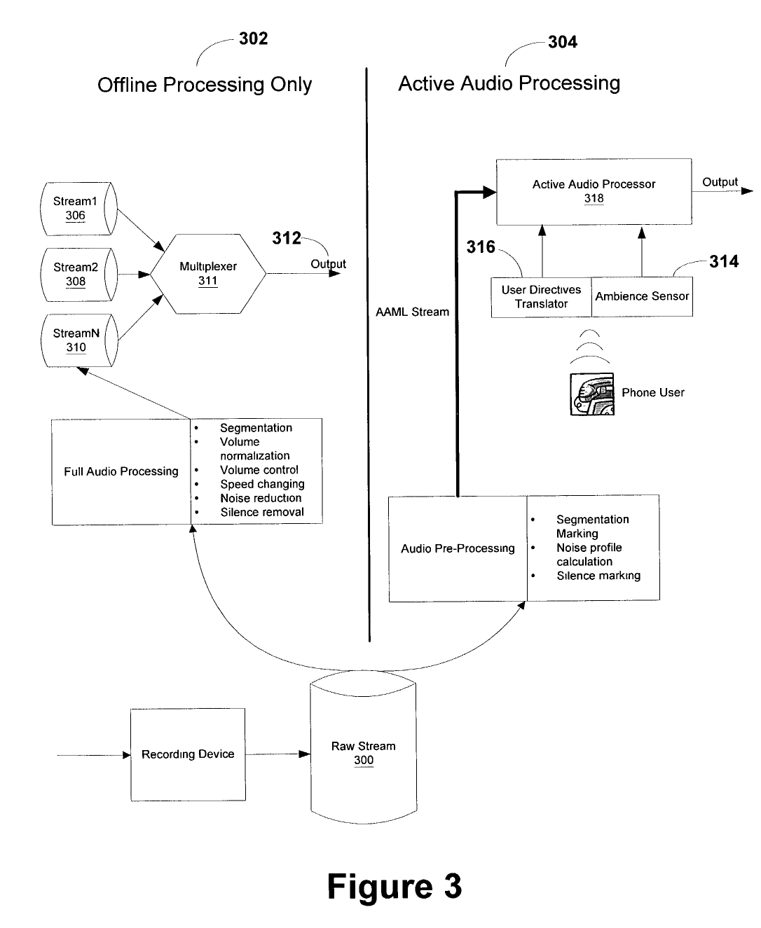

FIG. 3 illustrates how raw audio data in a database 300 is streamed via two modes: offline processing mode 302 or active (or real-time) audio processing mode 304. In the offline processing mode 302, full audio processing (such as segmentation, volume normalization, volume control, speed changing, noise reduction, silence removal, etc.) is done before streaming the audio data to the receiver device associated with a user (e.g., a telephone). This avoids having to implement expensive algorithms at the receiving device as the data is fully processed. Furthermore, since the audio data is fully processed prior to transmission, offline processing cannot be done in real-time, causing a time delay in the transmission of the audio stream. Active (or real-time) audio processing mode 304, on the other hand, allows for the transmission of an audio stream in real-time after minimal audio pre-processing (such as segmentation marking, noise profile calculation, silence marking, etc.)

In both the modes, the audio is first decomposed into frames of fixed width. Next, the information contained in each frame is encoded using meta-information such as audio markers and processing instructions, along with the native audio. For example, the location of segments with large intervals of silence, intervals corresponding to a particular speaker, and/or events such as the occurrence of certain keywords in the audio stream are determined. These markers are placed along with the timing information into the encoded AAML stream. In the offline processing mode, in addition to meta-information about the audio data, it is also possible to add processing instructions in the AAML stream. These instructions specify various operations such as silence removal, noise reduction filters, and mechanisms, which can be applied while delivering the information to specific users. For example, if a user has indicated interest in a specific speaker in his profile, the AAML decoder can detect the appropriate alert marker corresponding to the specific speaker and cue the user accordingly. Similarly, silence marking information in an active audio processing mode allows for large intervals of silence to be skipped during playback when a silence marker is detected in the AAML stream.

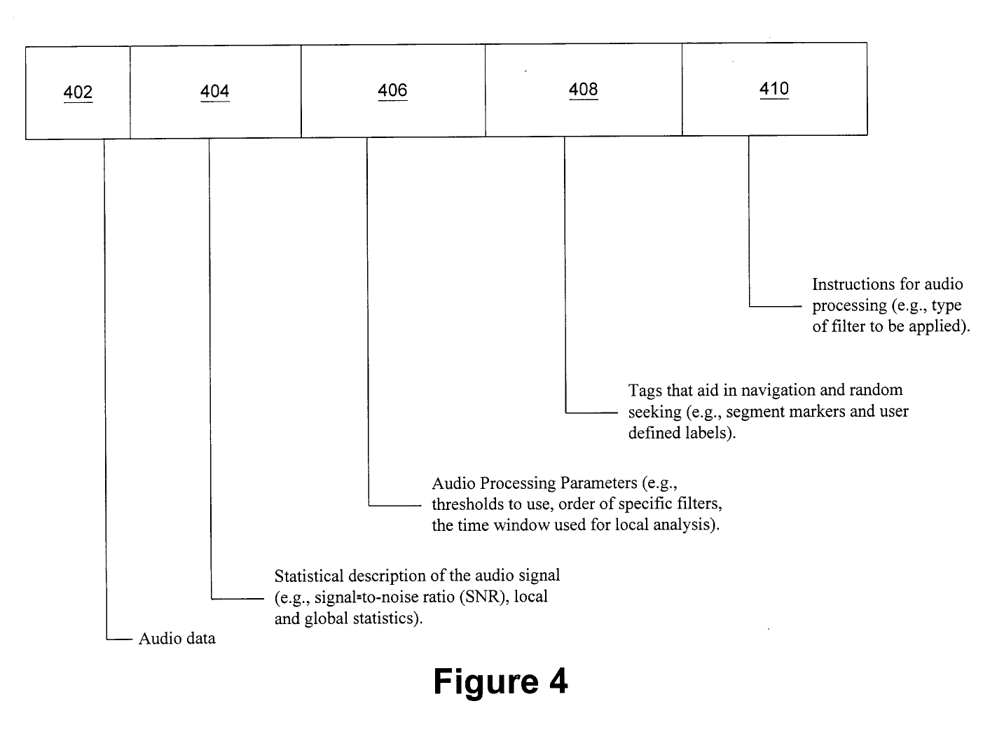

FIG. 4 illustrates a sample AAML stream that comprises the following blocks of information:

a. audio data 402.

b. a statistical description of the audio signal (e.g., signal-to-noise ratio, spectral information, timing information, and/or cross-correlation coefficients) 404, wherein the description consists of local and global statistics (local statistics are computed by analyzing small segments of the audio stream, while global statistical measures are computed by analyzing the entire signal) computed by processing the audio;

c. audio processing parameters (e.g., thresholds to use, order of specific filters, and/or the time window used for local analysis) 406;

d. tags which aid navigation and random seeking (e.g., segment markers and user defined labels) 408; these tags can be inserted by automatically processing the audio signal using the appropriate audio processing techniques, or they can be specified by the user; and

e. instructions for audio processing (e.g., type of filter to be applied) 410.

Returning to the discussion of FIG. 3, it should be noted that it is possible to multiplex (via multiplexer 311) several independent audio streams 306, 308, and 310 into one encoded AAML stream 312. This is useful, for example, when audio streams at multiple speeds are to be encoded simultaneously in the resulting AAML stream. In this case, audio streams at varying speeds are pre-computed and independently marked-up. The stream corresponding to the user's speed preference is then played back at run-time. Hence, it is possible to embed rich information with which application designers can take advantage, if desired, using the AAML codec provided as part of the architecture.

Additionally, an application designer can take advantage of real-time monitoring and sensing module capabilities to build intelligence into speech applications. Once the call is established in the above-mentioned example, the quality of the call is constantly monitored using sensors (such as ambience sensor 314). The application can be designed to adapt based on parameters such as background noise (static), user's location, and/or quality of connection. For example, background noise makes it hard for the user to communicate with automated systems. In such cases, the application could seamlessly enable noise reduction filters, adjust the volume to a suitable level, adjust confidence thresholds, and/or minimize speech recognition errors. In extreme cases, the application could offer to transfer the user to a human operator. Similarly, the user's location can be used by the application to suggest locations of noise-free environments or accessible phones. The availability of such features as part of the core architecture significantly benefits the application designer's task and the resulting user experience.

The processing and control module (implemented using an active audio processor 318) combines information received from all three components described above (user profile module that is implemented using a user directives translator 316, active audio markup module, and real-time monitoring and sensing module that is implemented using an ambience sensor 314) in a synchronized manner in real-time, interprets such information, and intelligently dispatches information to the application layer to achieve the desired behavior.

The processing and control module (implemented using an active audio processor 318) communicates with the user profile module (implemented using a user directives translator 316) by interpreting the user profile and setting the user's preferences for the entire session. It also communicates information to the learning component (103 of FIG. 1) of the user profile module, which analyzes the user's call pattern and updates the user profile as required.

Additionally, the process and control module (implemented using an active audio processor 318) uses the AAML codec to decode the AAML stream. As a result, the AAML stream is decomposed into audio data, semantic information, and/or processing instructions. As the audio data is played back, the synchronized semantic information is interpreted, and the appropriate event is generated (e.g., beeping the user when the speaker of interest begins speaking). The processing instructions are decoded, and the operation is carried out (e.g., skipping silences).

The process and control module (implemented using an active audio processor 318) communicates with the real-time monitoring and sensing module (implemented using ambience sensor 314) to monitor parameters of interest to the application. The application designer specifies which real-time sensed parameters should be used and how these should be interpreted in the application layer. The process and control module accordingly forwards this information to the application layer.

As described above, the IMPALA architecture provides a unique framework to develop intelligent speech-based applications. It solves specific problems, which hinder the wide deployment and efficiency of speech-based applications. The user profile module provides a novel manner in which applications can be built to learn from user's speech and navigation patterns. The active audio markup language is unique in respect that it provides a very powerful framework with which to represent multiple audio streams, descriptions of their content, and processing instructions. It will be obvious to those practiced in this art that this framework can be extended easily to devices of various modalities and form factors (e.g., telephones, hand-held computers, and/or specialized audio transcoders and transducers). The real-time processing and sensing module is an innovative approach, which allows a new breed of intelligent adaptive applications based on ambient conditions.

Furthermore, the present invention includes a computer program code based product, which is a storage medium having program code stored therein, which can be used to instruct a computer to perform any of the methods associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM or any other appropriate static or dynamic memory, or data storage devices.

Implemented in computer program code based products are software modules for implementing: a user profile module for customizing and learning preferences associated with one or more users; an active audio markup language (AAML) module providing an audio representation based upon a AAML codec; a real-time monitoring and sensing module for identifying variations in quality of service; and process and control module interacting with said user profile module, said AAML module, and real-time monitoring module wherein the process and control module: interacts with the user profile module to set user preferences based upon a user's profile; interacts with the AAML module to decode an AAML media stream, and/or interacts with the real-time monitoring and sensing module to interpret monitored real-time sensed parameters and forwarding the parameters to the application layer.

### Conclusion

A system and method has been shown in the above embodiments for the effective implementation of an intelligent media processing and language architecture for speech applications. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by media type (e.g., audio, video, static images, multimedia, etc), type of local or global statistics, type of audio processing parameters, type of tags, type of QOS parameters to be monitored, type of filter for audio processing, specific user preferences, software/program, computing environment, and/or specific hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT), and/or hardcopy (i.e., printed) formats. The programming of the present invention may be implemented by one of skill in one of several languages, including, but not limited to, C, C++, Java and Perl.

1. A modularized intelligent media processing and language architecture comprising:
a. a user profile module for customizing preferences associated with one or more users;
b. an active media markup language module providing a media representation based upon an active media markup language codec;
c. a real-time monitoring and sensing module for identifying variations in quality of service; and
d. a process and control module interfacing said user profile module, said active media markup language module, and said real-time monitoring module with an application layer;
wherein said process and control module: interacts with said user profile module to identify user preferences based upon a user's profile; interacts with said active media markup module to decode and forward, to said application layer, a media stream in an active media markup language format consistent with identified user preferences; and/or interacts with said real-time monitoring and sensing module to interpret monitored real-time sensed parameters and forwards said parameters to said application layer.

2. A modularized intelligent media processing and language architecture, as per claim 1, wherein said user profile module comprises a learning component for intelligently learning and recording preferences associated with said users.

3. A modularized intelligent media processing and language architecture, as per claim 1, wherein said media stream comprises the following information:
a. media data;
b. statistical description of said media data;
c. media processing parameters for processing said media data;
d. tags associated with said media data; and
e. instructions for processing said media data.

4. A modularized intelligent media processing and language architecture, as per claim 3, wherein said statistical description comprises any of the following: signal-to-noise ratio information, local statistics, or global statistics.

5. A modularized intelligent media processing and language architecture, as per claim 3, wherein said media processing parameters comprises any of the following: thresholds for processing said media data, order of filters for processing said media data, or time window of local analysis of said media data.

6. A modularized intelligent media processing and language architecture, as per claim 3, wherein said instructions for processing said media data comprises information regarding type of filter to be used to process said media data.

7. A method for facilitating entry and retrieval of audio data from a database using a modularized architecture comprising a user profile module, an active audio markup language (AAML) module, a real-time monitoring and sensing module, and a process and control module, said method comprising the steps of:
a. receiving vocal inputs from a communication device requesting audio information;
b. forwarding such requests to said database;
c. identifying user preferences associated with a user of said communication device, said identification done based upon an interaction between said process control module and said user profile module;
d. receiving requested audio information in an AAML formatted audio stream from said database;
e. decoding said audio stream via an AAML codec, said decoding based upon an interaction between said process control module and said AAML module;
f. identifying variations in quality of service associated with said communication device, said identification done based on an interaction between said process and control module and said real-time monitoring and sensing module; and
g. forwarding said identified variations in quality of service and decoded audio stream in a format consistent with said identified user's profile to said application layer.

8. A method as per claim 7, wherein said communication device is any of the following: telephones, wireless telephones, cellular telephones, WAP-enabled telephones, personal audio systems, audio playback systems, or wireless communication devices.

9. A method as per claim 7, wherein said method further comprises the step of intelligently learning and recording preferences associated with said user.

10. A system for facilitating entry and retrieval of audio data from a database via a communication device, said system comprising:
a. a speech-based application receiving vocal inputs from said communication device requesting audio information and forwarding such requests to said database; and
b. a modularized architecture interacting with said speech-based application and said database to enter and retrieve data, said modularized architecture comprising:
(i) a user profile module for customizing preferences associated with user of said communication device;
(ii) an active audio markup language (AAML) module receiving requested audio information as an AAML formatted audio stream from said database and decoding said audio stream via a AAML codec;
(iii) a real-time monitoring and sensing module for identifying variations in quality of service associated with said communication device; and
(iv) a process and control module interfacing said user profile module, said AAML module, and real-time monitoring module with an application layer associated with said speech-based application;
wherein said process and control module: interacts with said user profile module to identify said user's profile; interacts with said AAML module and forwards said decoded audio stream in a format consistent with said identified user's profile to said application layer; and/or interacts with said real-time monitoring and sensing module to interpret monitored real-time sensed parameters and forwarding said parameters to said application layer.

11. A method as per claim 10, wherein said communication device is any of the following: telephones, wireless telephones, cellular telephones, WAP-enabled telephones, personal audio systems, audio playback systems, or wireless communication devices.

12. A system as per claim 10, wherein said audio stream comprises the following information:
a. audio data;
b. statistical description of said audio data;
c. media processing parameters for processing said audio data;
d. tags associated with said audio data; and
e. instructions for processing said audio data.

13. A system as per claim 12, wherein said statistical description comprises any of the following: signal-to-noise ratio information, local statistics, or global statistics.

14. A system as per claim 12, wherein said audio processing parameters comprises any of the following: thresholds for processing said audio data, order of filters for processing said media data, or time window of local analysis of said audio data.

15. A system as per claim 12, wherein said instructions for processing said media data comprises information regarding type of filter to be used to process said audio data.

16. A system as per claim 10, wherein said user profile module comprises a learning component for intelligently learning and recording preferences associated with said user.

17. An article of manufacture comprising a computer usable medium having computer readable program code embodied therein for facilitating entry and retrieval of audio data from a database using a modularized architecture comprising a user profile module, an active audio markup language (AAML) module, a real-time monitoring and sensing module, and a process and control module, said medium comprising:
a. computer readable program code facilitating the reception of vocal inputs from a communication device requesting audio information;
b. computer readable program code forwarding such requests to said database;
c. computer readable program code identifying user preferences associated with a user of said communication device, said identification done based upon an interaction between said process control module and said user profile module;
d. computer readable program code receiving requested audio information in an AAML formatted audio stream from said database;
e. computer readable program code decoding said audio stream via a AAML codec, said decoding based upon an interaction between said process control module and said AAML module;
f. computer readable program code identifying variations in quality of service associated with said communication device, said identification done based on an interaction between said process and control module and said real-time monitoring and sensing module; and
g. computer readable program code forwarding said identified variations in quality of service and decoded audio stream in a format consistent with said identified user's profile to said application layer.

18. An article of manufacture as per claim 17, wherein said medium further comprises computer readable program code learning and recording user preferences.
